(19) United States
(12) Patent Application Publication
(10) Pub. No.: US 2025/0377282 A1
(43) Pub. Date: Dec. 11, 2025

(54) LED INTENSITY DECAY PARTICLE TRACKING VELOCIMETRY

(71) Applicant: United States of America as represented by the Administrator of NASA, Washington, DC (US)

(72) Inventors: Joshua M. Weisberger, Newport News, VA (US); Brett F. Bathel, Newport News, VA (US)

(21) Appl. No.: 18/735,255

(22) Filed: Jun. 6, 2024

(51) Int. Cl. G01N 15/1434; G01N 15/00; G01N 15/10; G01N 15/1429

(52) U.S. Cl. CPC G01N 15/1434; G01N 15/1429; G01N 2015/0003; G01N 2015/1027; G01N 2015/1445

(57) ABSTRACT

A Particle Tracking Velocimetry (PTV) system and method encodes particle tracks with a known monotonic intensity variation to provide high-resolution particle velocity and directionality information. One or more light-emitting diodes (LEDs) is utilized as the light source, and the intensity variation may result from a capacitance discharge rate in an LED pulsing circuit. A single-camera/single-LED system may be utilized to two-dimensional motion of particles, and a two-color system may be utilized to determine three-dimensional motion of particles toward or away from the camera.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Particle Image Velocimetry (PIV) is a known optical diagnostic for the measurement of flow velocity. Generally, a light source is formed into a sheet with a combination of spherical and cylindrical optics (“sheet-forming optics”) and illuminates a flowfield of interest. The flowfield may be seeded with small particles that are nearly neutrally buoyant such that they follow the local direction of the flow. A camera placed orthogonal to the plane of the light sheet captures images of the particles illuminated by the light through scattering. Typically, to obtain the velocity of the flowfield, the light source and camera are synchronously double-pulsed in quick succession, acquiring two images of the particle field at two closely separated instances in time. These two images are then compared, often using a cross-correlation or optical flow algorithm, and the velocity field is obtained. To achieve high intensity, light uniformity, and accurate pulsing control, lasers may be used as the light source. However, LED light sources have also been used. Because particles are made visible by a sheet of light, conventional PIV systems are inherently two-dimensional, limited to the plane of illumination. Stereoscopic PIV uses a second camera to resolve the out-of-plane component of the velocity. Examples of other three-dimensional PIV techniques are scanning PIV, defocusing PIV, holographic PIV, tomographic PIV, and synthetic aperture PIV.

When the pulse width of the light source and exposure of the imaging system are deliberately increased to record streaks of each particle (akin to motion blur in long exposure images), the technique is typically called particle streak velocimetry (PSV), particle streak tracking (PST), or particle tracking velocimetry (PTV), among other similar names; the acronym of PTV will be used herein for clarity.

### BRIEF SUMMARY OF THE INVENTION

An aspect of the present disclosure is a method of determining velocity of particles. The method includes driving an LED with a trigger pulse to generate a pulse of light from the LED having an intensity that decays. The intensity of the pulse of light is measured as the intensity decays over time whereby the measured intensity comprises a correlation between intensity and time. The method further includes illuminating a moving particle utilizing the pulse of light. The method further includes capturing an image comprising a streak, wherein the streak is formed by the moving particle while the moving particle is illuminated by the pulse of light. The method further includes determining a distance traveled by the moving particle between first and second points on the streak, and a corresponding decay in the intensity of the streak is also determined. The correlation between intensity and time is utilized to determine the time to move the distance. The method further includes determining a velocity of the moving particle based on a ratio of the distance to the time to move the distance.

Another aspect of the disclosure is a method of measuring velocity and direction of a flowfield. The method includes seeding the flowfield with particles, and illuminating the particles in the flowfield utilizing first and second side-by-side sheets of pulsed light comprising first and colors of light, respectively. The first sheet of pulsed light is formed by a first LED that emits a pulse of light, and wherein the intensity of the pulse of light decays to define a first decay profile comprising light intensity over time. The second sheet of pulsed light is formed by a second LED that emits a pulse of light, wherein the intensity of the pulse of light decays to define a second decay profile comprising light intensity over time. The method further includes capturing images of the illuminated particles utilizing a camera such that the images of the illuminated particles comprise streaks of the first and second colors, and wherein intensities of the streaks decay along the lengths of the streaks. The first and second decay profiles are measured utilizing a portion of the pulsed light from the first and second LEDs, and the intensities of the measured first and second decay profiles are utilized to determine velocities and directions of movement of particles along paths corresponding to the streaks.

Another aspect of the present disclosure is a method for determining movement of particles. The method includes utilizing first and second LEDs to form pulses of light having first and second colors, respectively, wherein intensities of the pulses of light vary. The method further includes illuminating particles in adjacent first and second volumes of a flowfield with pulsed light from the first and second LEDs, respectively. A camera is utilized to acquire images of particles in the first and second volumes, wherein the images comprise streaks. The intensity of light during the pulses is measured to form intensity profiles that correlate light intensity and time. The intensity profiles are utilized to determine directions of movement of the particles. The two-color streaks comprising segments having first and second colors are utilized to determine if a component of movement along an axis of the camera is positive or negative based on an orientation of the first and second color segments of the two-color streaks.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a schematic top plan view of a single-color LED intensity decay PTV system;

FIG. 2A is a schematic of a single-color system viewing an LED light sheet from the side (90° scatter);

FIG. 2B is a graph showing an LED pulse intensity decay profile of the system of FIG. 2A;

FIG. 2C is a schematic camera image showing three characteristic particle streaks;

FIG. 2D is a schematic top plan view of the LED sheet of FIG. 2A with three characteristic particle streaks;

FIG. 3 is a schematic top plan view of a two-color system having a single color or monochrome camera;

FIG. 3A is a schematic top plan view image of the mirrors and red and blue light sheets adjacent to one another above a particle jet;

FIG. 4A is a simplified schematic of the two-color system of FIG. 3 viewing an LED sheet from the side (90° scatter);

FIG. 4B is a graph showing LED pulse intensity decay profiles for two LED colors of the system of FIG. 4A;

FIG. 4C is a schematic camera image showing three characteristic particle streaks;

FIG. 4D is a schematic top plan view of the LED sheets of FIG. 4A with three characteristic particle streaks;

FIG. 5 is a schematic top plan view of a two-color system, wherein two monochrome cameras are used to increase imaging resolution/quality, and both cameras view the same scattering angle and field-of-view through the use of a dichroic mirror;

FIG. 6A is an image of raw particle streaks;

FIG. 6B is an image showing automatic edge detection of the identified particle streaks, wherein edge detection can be used to automatically extract intensity decay profiles of the particle streaks;

FIG. 7 shows processing steps used to high-pass filter a raw PTV image to remove background and out-of-focus particle streaks;

FIG. 8A is a graph showing red and blue LED intensity decay profiles for three pulse widths of 100 μs, 200 μs, and 300 μs (measured by the photodiodes of FIG. 3) in which the traces are offset vertically for clarity;

FIG. 8B is a graph of green LED intensity decay profiles for various pulse widths;

FIG. 9A is a raw single-color LED monochrome image of a freestream flow from a jet (wherein the flow is from bottom to top);

FIG. 9B is a raw single-color monochrome chaotic region of opposing jet flow, with three particle streaks identified;

FIG. 10 comprises images of flow around a cylinder obstruction for three LED pulse widths: 100 μs (left), 200 μs (middle), 300 μs (right), in which flow is from bottom to top;

FIG. 11A is a color camera image of the two-color (red, blue) PTV system of FIG. 3 with a nozzle located at the left side of the image and flow from left to right, and wherein the red and blue light sheets are made visible by a piece of paper at the camera's plane of focus;

FIG. 11B is a camera image corresponding to the image of FIG. 11A, the image comprising a cropped-view of the particle flow at the red/blue light sheets;

FIG. 12A is two-color monochrome image of a sideways-facing jet nozzle, with red and blue particles outlined in respective colors, wherein approximate locations of the light sheets are depicted with highlighted colored regions;

FIG. 12B is a graph showing normalized intensity decay profiles of red and blue particles with measured photodiode intensity decay signal from LEDs;

FIG. 13A is a graph showing raw (color) and smoothed (gray) intensity decay profiles for red and blue particles corresponding to FIGS. 12A and 12B;

FIG. 13B is a graph showing sub-interval velocities in m/s for red and blue particles plotted along the intensity decay profile; and

FIG. 13C is a graph showing the velocity of particle streak sub-intervals over particle distance, where dashed lines indicate mean streak velocity;

### DETAILED DESCRIPTION OF THE INVENTION

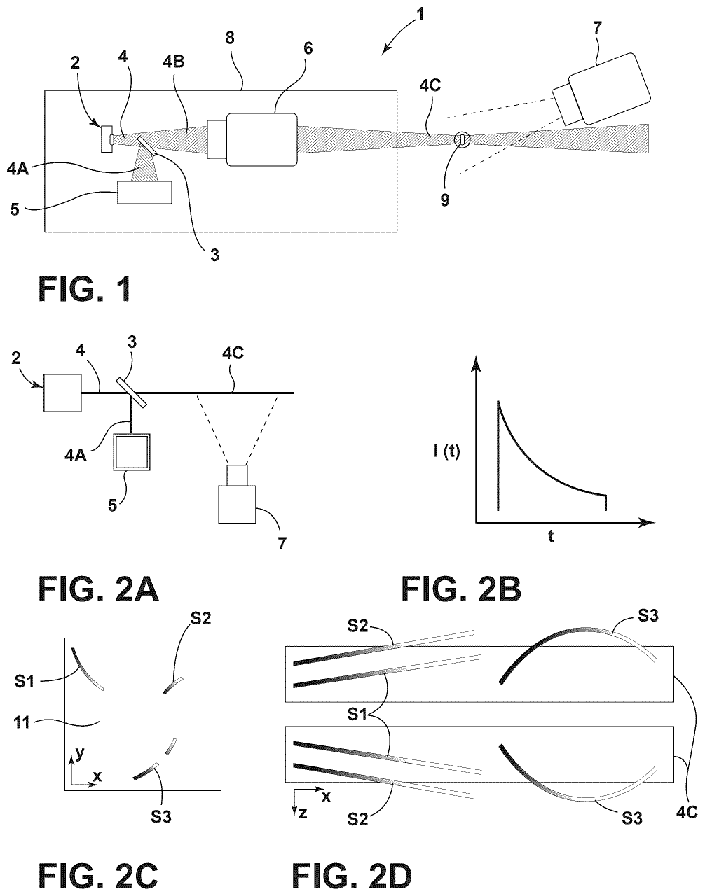

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

A schematic top plan view of a single-color system 1 is shown in FIG. 1. System 1 includes a light source 2, pick-off mirror 3, and a lens 6 which may be mounted on a breadboard 8. Light source 2 may comprise a red LED which outputs a defined intensity profile in time, where the total duration of the decay is determined by the input TTL trigger duration (i.e., pulse width). Pick-off mirror 3 reflects a small portion of the light 4A to a detector 5 to be used as an intensity monitor. The transmitted light 4B passes through lens 6 to form an image of the LED element at the measurement location (e.g., a low velocity jet 9 with 1 μm particles in the flow). A monochrome camera 7 views the flow of interest from a nearly-forward-scattering orientation to achieve high signal intensity. Because the light 4C illuminates the entire volume of the particle jet 9, the narrow depth-of-focus of the imaging plane is achieved through appropriate combination of the camera, lens, and extension tubes. This type of imaging strategy is generally known, and the imaging plane is determined by the imaging system depth-of-focus, not the illumination sheet thickness. Various imaging angles can be used, however, provided the illumination intensity and camera sensitivity are sufficient to acquire high enough pixel intensities of the particles over their streak duration.

A top-down schematic of a single-color system is shown in FIG. 2A. Single-color system includes an LED 2, a beamsplitter such as pick-off mirror 3, and detector 5. Pick-off mirror 3 directs some light 4A to detector 5 to measure the intensity decay of each pulse, and the light 4 forms a sheet 4C with beamforming optics (which are not shown in FIG. 2A, but are generally known in the art). The camera 7 is configured to image the orthogonally scattered light 4C from the LED 2. The intensity decay profile, I (t), of the LED 2 measured by the detector 5 is shown in FIG. 2B, exhibiting monotonic exponential decay in time. The duration of this intensity decay in time is determined by the pulse width (time) of the LED 2, which may be set using an input TTL pulse to the LED circuit, whereas the decay rate within this pulse width is dictated by the LED circuit's design, and is typically influenced the resistance and capacitance of the circuit.

A representative camera image 11 with three (of many) possible measured particle streaks S1-S3 is shown in FIG. 2C. A top view of the LED light sheet 4C is shown in FIG. 2D, with the correspondingly-numbered particle streaks denoted. For streak S1, the particle remains within the thickness of the illumination sheet 4C over the duration of the pulse width, and the full streak S1 is captured on the camera sensor. For streak S2, the particle exits the illumination sheet 4C before the pulse concludes, and so the streak appears shortened in the camera image. It is also noted that the particles can enter the sheet 4C instead of exiting the sheet 4C, but the intensity profile will indicate which of these occurs. For streak S3, the particle exits the illumination sheet 4C, and then re-enters a short time later. This appears in the camera image as a particle streak with a missing section in the middle. The two top-view images of the illumination sheet 4C and streaks in FIG. 2D are equally valid scenarios for the images acquired by the camera 7 in FIG. 2C. To avoid this directional ambiguity, a two-color system can be used.

While single-frame (longer exposure) imaging can provide high-quality, easy-to-interpret images, it is known that in three-dimensional fields foreshortened image streaks are created when particles enter or leave the light sheet during the exposure. It is also known that this third component of velocity can be determined by using color-coding of adjacent light sheets. It is also known that if the measurements are being performed in liquids, absorption of different wavelengths of light through the liquid when scattered by the suspended particles can provide information on the third component of velocity (out-of-plane). In the single-color system 1 described above, the directional ambiguity of particle streaks using a single color was exemplified in the schematic of FIG. 2D. In single-color systems, particle streaks that are shorter than the duration of the LED pulse, and thus have significant out-of-plane motion, can be discarded during a pre-processing validation step.

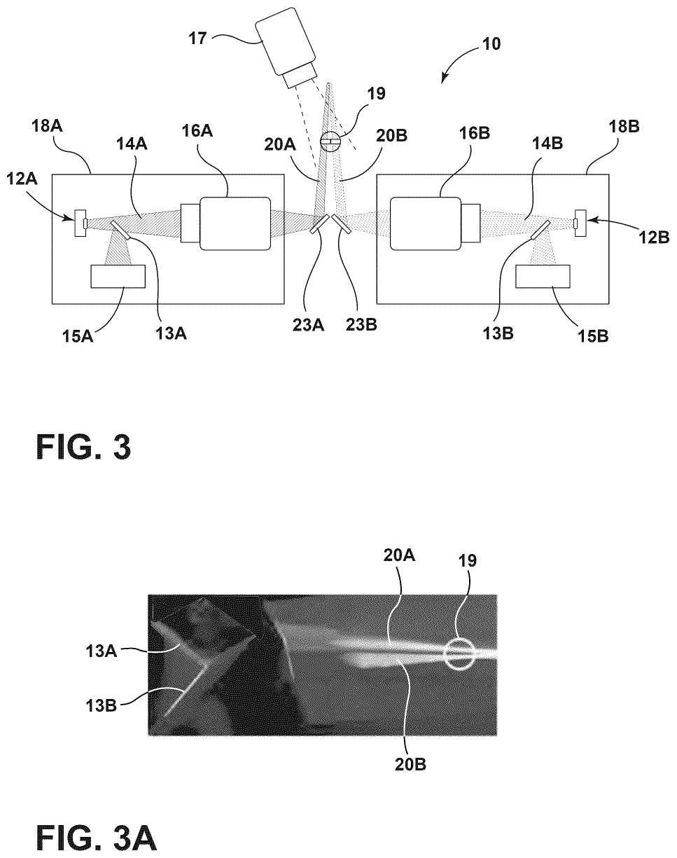

However, as described below, if the out-of-plane particle streaks are to be utilized, a two-color system according to the present disclosure (e.g., FIG. 3) can be used. It is noted that when using volumetric illumination such as is typical for the LED systems described herein, a third component of velocity can also be obtained using a single LED with two cameras, each focused on a narrow plane offset from one another, and performing a volumetric calibration to determine the particle position.

An LED intensity decay PTV system 10 according to an aspect of the present disclosure may comprise a two-color (multi-color) system including at least two LED units and associated optics. A schematic of a two-color (e.g., red and blue) system is shown in FIG. 3. In this example, the configuration of the optics for both separate color LED portions of the system may be the same, and may be substantially similar to the design of the single-color system shown in FIG. 1. System 10 (FIG. 3) includes a red LED 12A and a blue LED 12B and the light 14A, 14B may be reflected by turning mirrors 23A, 23B, respectively, to provide precise angular adjustment of the reflected beams 20A, 20B (sheets) to align them optimally above particle jet 19, approximately adjacent to one another. A top view of the red and blue light sheets 20A, 20B is shown in FIG. 3A, where the light 20A, 20B is made visible using a piece of paper to show the focusing light beams/sheets/rays 20A, 20B. It will be understood that, as used herein, “two-color system” generally refers to any multi-color system, which may include two or more colors.

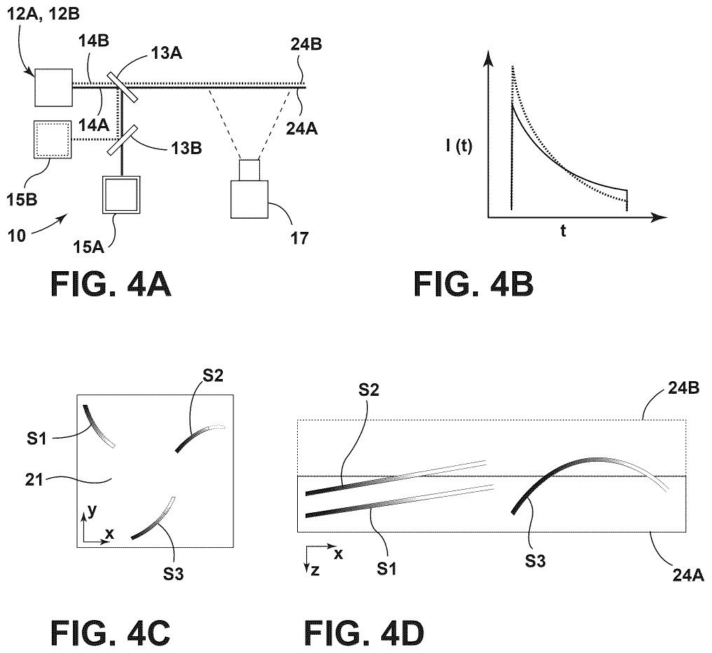

A simplified schematic of the two-color system 10 is shown in FIG. 4A, where the light 14A, 14B from the LEDs 12A, 12B is initially split by a beamsplitter 13A, with a portion being reflected and the remaining light transmitted as two adjacent planes or sheets 24A, 24B to the flow region of interest, which is viewed orthogonally by a color camera 17. The reflected light is split by a dichroic beamsplitter 13B (longpass in this schematic), with the blue and red light detected separately by two photodiodes 15A, 15B to measure the intensity decay of the light from LEDs 12A, 12B. These intensity decay profiles are shown in FIG. 4B, noting that the two LEDs 12A, 12B need not have the same decay pattern, since both are recorded simultaneously. The duration of the two pulses is the same in this example. However, this is not a fixed requirement given that two separate TTL pulses are supplied to the two LEDs 12A,12B, and the camera exposure is longer than the longest LED pulse width.

The utility of the two-color system 10 compared with the single-color system is shown in FIGS. 4C and 4D. A camera image 21 of three (of many) possible characteristic streaks is shown in FIG. 4C, and a top view of the adjacent illumination sheets is shown in FIG. 4C. The three streaks S1-S3 are the same as those shown in FIGS. 2C-2D. For streak S1, the imaged streak on the camera is the same as shown in FIGS. 2C-2D because the particle remains within the confines of the red sheet 24A. For streak S2, the first part of the imaged streak is red, and then transitions to blue as it passes out of the red sheet 24A and into the blue sheet 24B. For streak S3, the camera image 21 shows the streak passing from the red 24A to the blue 24B and back to the red sheet 24A, and the directionality of the particle over its streak duration is evident.

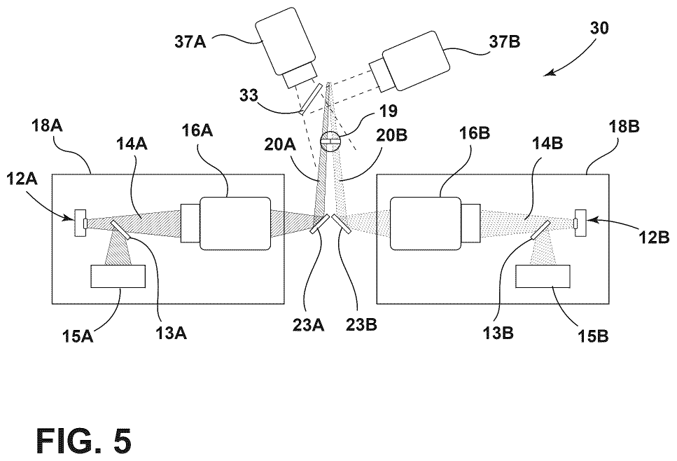

The single-color camera system 10 setup of FIG. 3 may result in imaged streaks that are of lower quality than when using a monochrome camera, typically due to the color mask present on the sensors of color cameras. A two-color system 30 (FIG. 5) may provide increased resolution and quality. In the arrangement of FIG. 5, a dichroic mirror 33 is used to split the scattered light from the blue and red LEDs 12A, 12B to be imaged by two monochrome cameras 37A, 37B, each viewing the same scattering angle and field-of-view through the use of the dichroic mirror 33. A single monochrome camera can also be used in place of the color camera 17 (FIG. 3) if it is clear from a pre-run calibration which parts of the image correspond to each LED's illumination. This is not excessively difficult if the intensity decay profiles of the two LEDs 12A, 12B are sufficiently different.

With regards to image processing, a two frame cross-correlation method may be utilized to process conventional PIV images. In this method, two images are acquired by double-pulsing both the light source and the imaging camera, with a precisely known delay time between the first and second pulse/image. A windowed cross-correlation calculation results in estimated 2D velocity vectors in the imaging plane, albeit at a lower resolution than the initial images due to the windowing used in the processing method. This processing method is generally known such that further details of this processing method are not provided herein.

To obtain the necessary velocity information of the particle streaks in the images, other processing steps may be required beyond the typical cross-correlation method. An option for streak processing is to treat the start and end point of the streaks as the two “frames” from a conventional double-image PIV test, since the streak duration time is known (akin to the dual-pulse offset in traditional PIV measurements). The velocity vector calculated from this data ignores the path of the particle between the start and end of the streak, omitting useful information about the flow. Since the imaged intensity decay streaks are exponential in nature due to the capacitor discharge, known processing methods can be used. Other options for streak processing are also known.

To obtain information from the streak images, the streaks are first identified in the image. Manual identification is typically possible, but it may be time-consuming. Edge detection or image segmentation algorithms can be used to automatically find streaks in the images instead of manually selecting them.

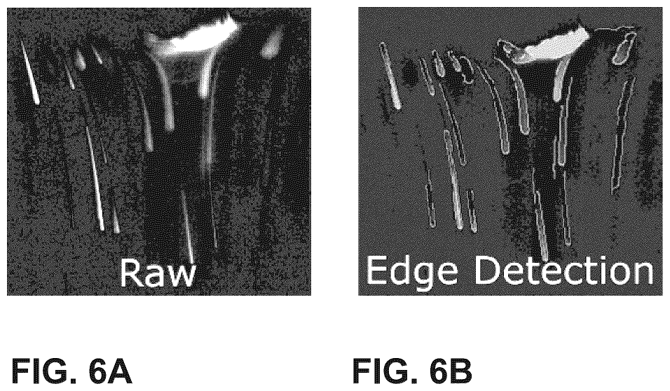

An example of a raw image is shown in FIG. 6A, and automatically identified streaks are shown in FIG. 6B. Using these identified regions, the intensity profile from beginning to end of each streak is extracted, and can be used with the known (measured) intensity decay for that image frame. It is noted, however, that in FIGS. 6A and 6B, both in-focus streaks at the left of the image and out-of-focus streaks at the center/right of the image are identified, and manual adjustment of processing parameters or outlier removal may be needed.

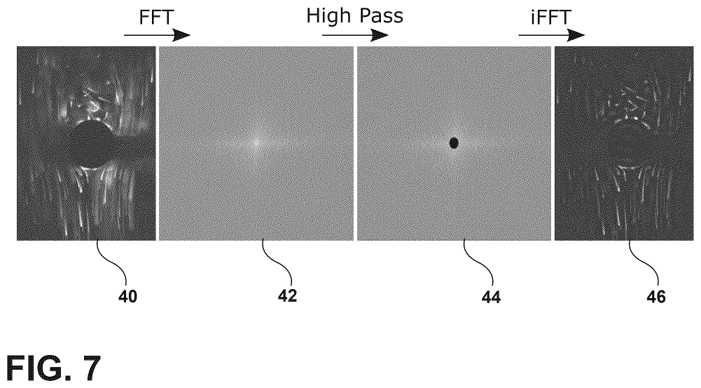

If there are numerous out-of-focus particles in the image (e.g., due to a higher than expected seeding density), a high-pass filtering of the image (FIG. 7) may (optionally) be performed prior to streak identification and intensity extraction, to identify particles only at the sharpest plane of focus of the imaging system. In the example of FIG. 7, a 2D Fast Fourier Transform (FFT) (image 42) of the raw image (image 40) is first computed. To perform a high-pass filtering of the image, an arbitrary circular portion of the FFT image is removed from the center (image 44), which corresponds to the lowest frequencies in the image. Finally, the inverse FFT is computed, resulting in the high-pass filtered image 46 at the right of FIG. 7. Comparing the raw and filtered images 40, 46 shows a pronounced reduction in the out-of-focus particle streaks, allowing the in-focus particle streaks to stand out and making the edge detection algorithm more efficient. It is noted, however, that the out-of-focus particle streaks do contain information about out-of-plane position of the particles, and their position in 3D space can be determined with calibration of particle blur versus position away from the plane-of-focus prior to testing.

The intensity profile across the light sheet will affect that actual scattered intensity imaged by the camera, in a way that changes the recorded intensity decay profile from the actual light decay. For example, if the light sheet has a Gaussian profile across its width, then a particle moving from the middle of the sheet to the edge of the sheet will exhibit a Gaussian decay of its intensity that is independent of its scattered intensity decay profile, I (t). This can be accounted for by taking a sheet-intensity calibration image prior to the experiments, and adjusting the recorded images by this calibration image. Intensity-graded light sheets are generally known.

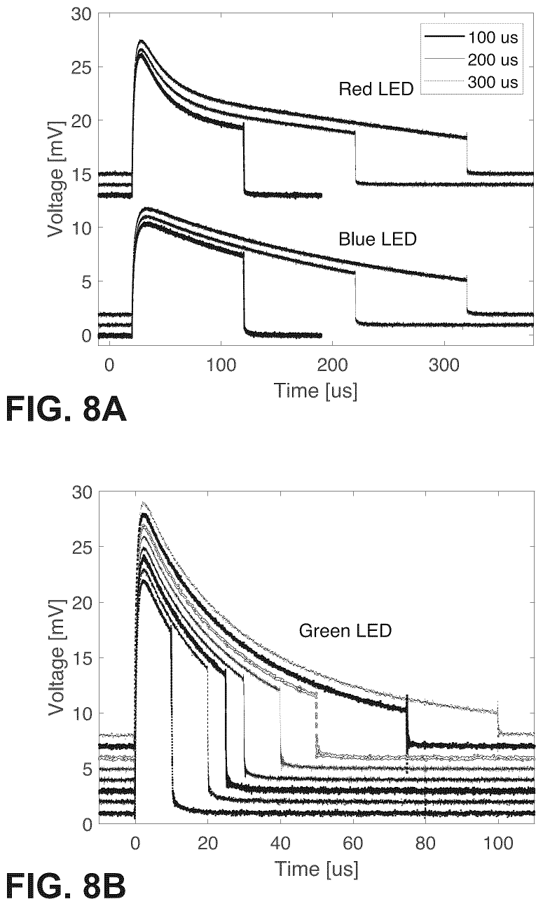

In testing, red LED 12A (PT-120-RAX) and blue LED 12B (PT-120-B) of FIG. 3 were connected to a driving circuit board powered by a 12 V DC power supply, and a trigger source was utilized to provide a TTL pulse whose width defined the duration of the streak illumination. For the following testing discussions, LED pulse widths of either 100 μs, 200 μs, or 300 μs were used. The time traces of the three pulse widths for the blue and red LEDs 12A, 12B are shown in FIG. 8A, where the traces have been offset vertically for better visual comparison.

Different resistors and capacitors may be included in the pulsing circuit design to provide different decay profiles. For example, the decay profile from the blue LED 12B shows a more gradual decrease in intensity than the red LED 12A, a result of different capacitors being used in the two circuits. Each of the three pulse widths used and plotted in FIG. 8A ensure that the LED intensity does not decrease to a value that is too close to the “off” intensity. This is to maintain the scattered streak signal at a level that can still be imaged by the camera with a high enough signal-to-noise ratio, and also to provide a definitive end-point to the streak such that the rudimentary start-to-end point processing discussed above in connection with FIGS. 6A and 6B can be used to give an initial estimate of the velocity field.

For higher speed flows, these pulse width durations (and thus streak lengths) may be too long. By changing the capacitance values of the circuit, the decay time can be lowered even further, as shown in FIG. 8B. Here, a green LED (PT-120-G) was used for the illumination, with data traces acquired for eight pulse widths (10, 20, 25, 30, 40, 50, 75, 100 μs), and which are offset vertically for clarity in FIG. 8B. Because only the pulse width was changed between data sets and not the capacitance of the circuit, the general decay profile is the same for all pulse widths, only truncated for the shorter pulse widths. These differences in decay profiles and decay times demonstrate the versatility of the illumination source, although the resistance/capacitance of the circuit is preferably tailored to the expected flow velocities of the fluid utilized in the experiment. For example, the optimal decay profile may depend on the camera imaging magnification, the mean flow velocity, the seeding density, etc.

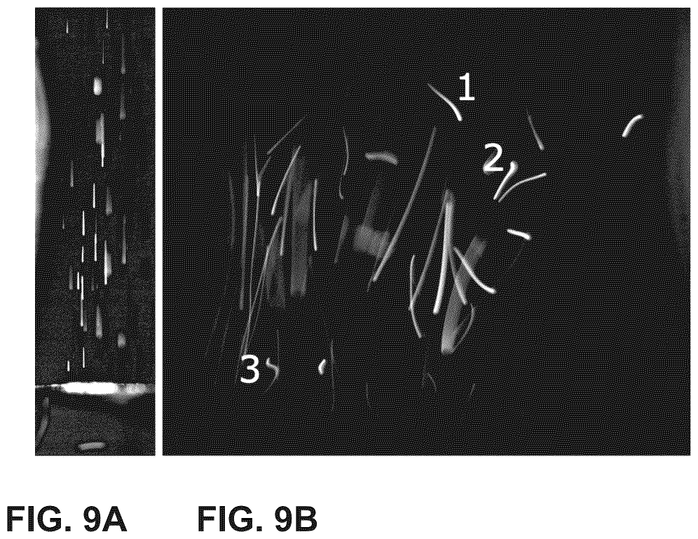

As an initial qualitative demonstration, the single-color system (using a red LED) shown in the schematic of FIG. 1 was used to image the flow from a small diameter nozzle, as shown in the camera image of FIG. 9A, where flow is from bottom to top. The edge of the nozzle can be identified by the reflection near the bottom of the image. Because the camera depth-of-focus is narrow, there are particles near the front and back of the jet that are out of focus in the images. The sharp particle streaks in the image are those particles that occur in the narrow depth-of-focus of the camera system. The forward scattering configuration of this system resulted in relatively high signal intensity.

To demonstrate the utility of the intensity decay illumination for particle direction determination, an opposing jet was placed above the upward-facing jet from FIG. 9A, facing in the opposite direction, without particles present in its flow. A resulting image from this opposing jet flow is shown in FIG. 9B, with three labeled particle streaks showing different characteristics. Streak 1 is moving towards the top-left of the image, whereas streak 2 is moving towards the bottom-left of the image, based on their intensity decay profiles. Streak 3 displays an ‘S’ shape, where the direction of the particle changes multiple times within the pulse duration. Other characteristics of the flow that can be visually identified from this image are that the longer streaks near the left side of the image are moving faster than the shorter streaks near the right side of the image, because the entire flowfield is illuminated with light of the same pulse duration.

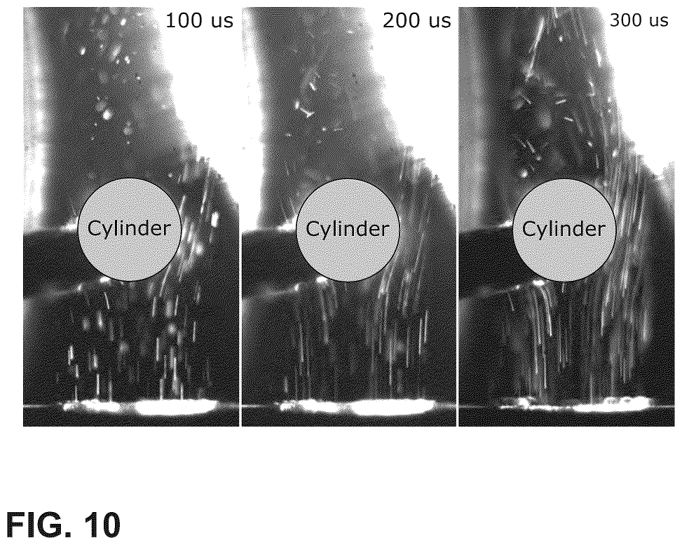

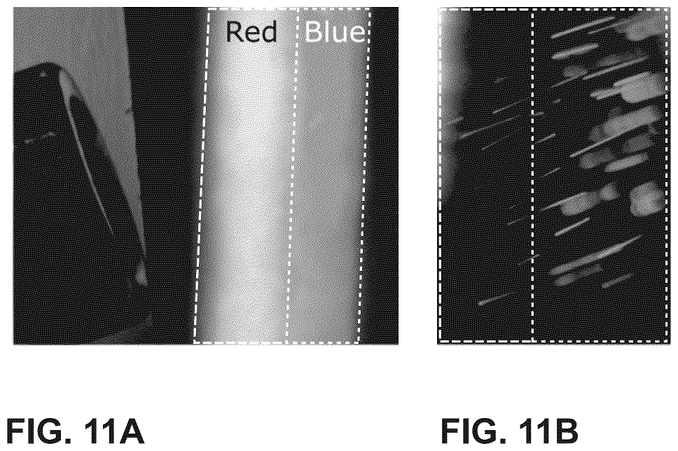

If there are regions of the flowfield being measured that have sufficiently different flow velocities, then a single pulse width duration may not be suitable for both regions, and may cause problems during the image processing stages of the analysis. For example, images of the flow around a cylinder obstruction are shown in FIG. 10 for three pulse widths (100 μs, 200 μs, 300 μs), where the flow is from the bottom to the top of the image. The edge of the particle jet nozzle can be seen at the bottom of the image, the cylinder near the center, and the bright region from the LED light source in the camera field-of-view near the top right (a result of the forward scattering orientation shown in FIG. 1). The brightness of the image (FIG. 10) has been increased to more clearly show the particle tracks, even though many of them are saturated.

Two distinct regions of flow are visible in the images of FIG. 10: 1) freestream flow below the cylinder, and: 2) the wake flow above the cylinder. The freestream flow has a higher velocity than the wake flow, and so the particle streaks are long and relatively straight, aside from the region close to the cylinder surface as they begin to curve around its profile. In the wake, the velocity is low and the particles move in many different directions. In the freestream flow, the 100 μs pulse width provides good quality images of the streaks, without their lengths becoming so long that they interfere with other particle streaks, as can happen with the longer pulse widths of 300 μs. For the wake, the pulse width of 300 μs provides the best particle streaks of these slower moving particles, allowing for high quality determination of both the direction and the velocity of these wake particles. A compromise can be made to obtain adequate imaging of different velocity streaks by using a pulse width of 200 μs, as shown in the middle image of FIG. 10. Both the freestream streaks below the cylinder and the wake streaks above the cylinder have adequate lengths for determination of the velocity profile in the entire image.

A two-color system using both red and blue LEDs 12A, 12B was constructed according to the schematic of FIG. 3. Two configurations of this setup were used, the first using the depicted color camera 17, and the second replacing the color camera with a monochrome camera. It is noted that the configuration shown in FIG. 5 using two monochrome cameras 37A, 37B with scattered light split by a dichroic mirror 33 could also be used, but was not in these experiments because, as shown in FIG. 8A, the intensity decay curves for the red and blue LEDs 12A, 12B were sufficiently different such that the light sheets 20A, 20B could be differentiated from each other using a monochrome camera by evaluating the extracted intensity decay curves from the image.

For these tests, the jet was angled sideways, pointed slightly upwards with flow from left to right, as shown in the image of FIG. 11A. Here, the exit of the nozzle is seen at the left of the image, and the adjacent red and blue light sheets are made visible with a piece of paper centered at the plane of focus of the camera system (note that the red light sheet appears yellow in the color camera's images, as there is some wavelength sensitivity overlap between the filters for the color channels). A cropped view of the particles passing through the two light sheets is shown in FIG. 11B, with particles illuminated by the red LED at the left and particles illuminated by the blue LED at the right. Some particles can be seen passing from the red sheet to the blue sheet within the duration of the LED pulse. However, it appears that the intensity decreases and then increases again during the particles' motion, which can be attributed to the non-uniformity of each light sheet over its width. This can be accounted for during calibration to provide a background intensity, which maps the intensity of the light sheets to each pixel prior to illumination of the particle flow. It is also noted that there are out-of-focus particles, particularly in the blue illumination sheet, and these can be filtered using high-pass filtering of the images as described above.

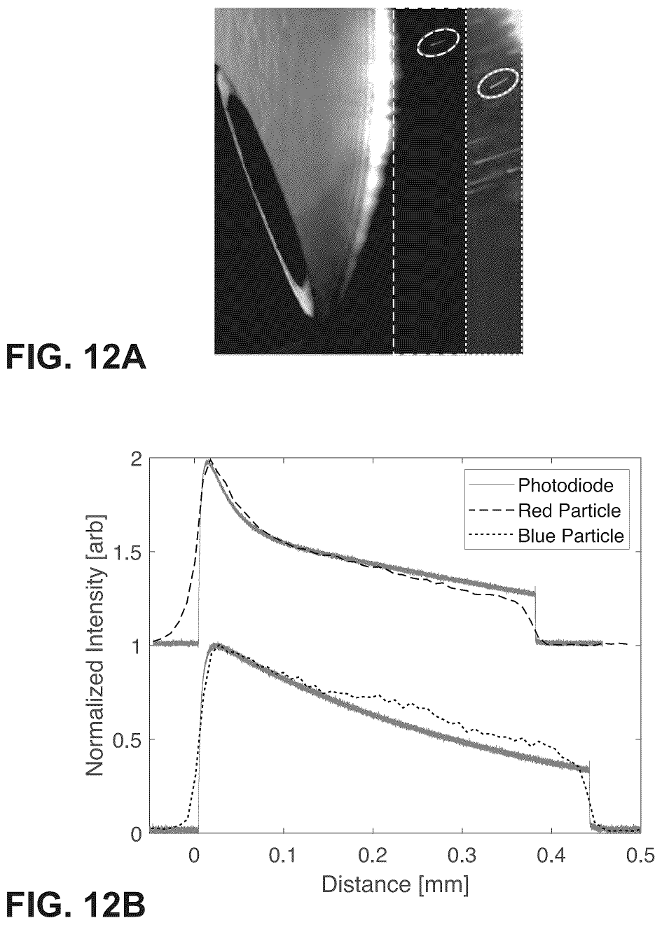

A monochrome camera image of the two-color LED illumination is shown in FIG. 12A, wherein the rough position of the red and blue illumination sheets are depicted with the appropriately colored rectangles, and two streaks are identified, one in each light sheet. A Ronchi ruling (5 line pairs per millimeter) was used to obtain a spatial calibration of the image. The extracted intensity profile of each streak is shown with its respective color in the plot of FIG. 12B, with the simultaneously measured photodiode profile for each shown in gray (measured using 15A, 15B). The intensities of both the image profiles and the photodiode profiles are normalized between zero and unity for comparison purposes. It is noted that the distance traveled by the blue particle is slightly greater than the distance traveled by the red particle during the same pulse width duration of 300 μs, indicating that the blue particle has a larger velocity.

Various methods can be used to extract quantitative information from the image. A first method is to identify the starting and ending points of each particle streak, and use the LED pulse width to determine the velocities of the particles. The correct orientation of the particle streaks (the starting and ending points) are known due to the intensity decay direction, but this method may discard information about the velocity and position of the particle along its path within the duration of the pulse width. From the streak data shown in FIG. 12B and using the pulse width of 300 μs, the velocities of the red and blue particle streaks are roughly 1.26 m/s and 1.47 m/s, respectively.

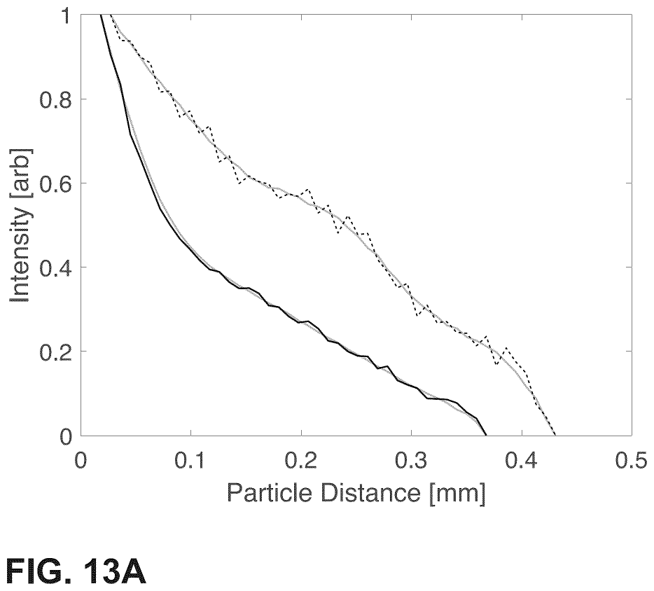

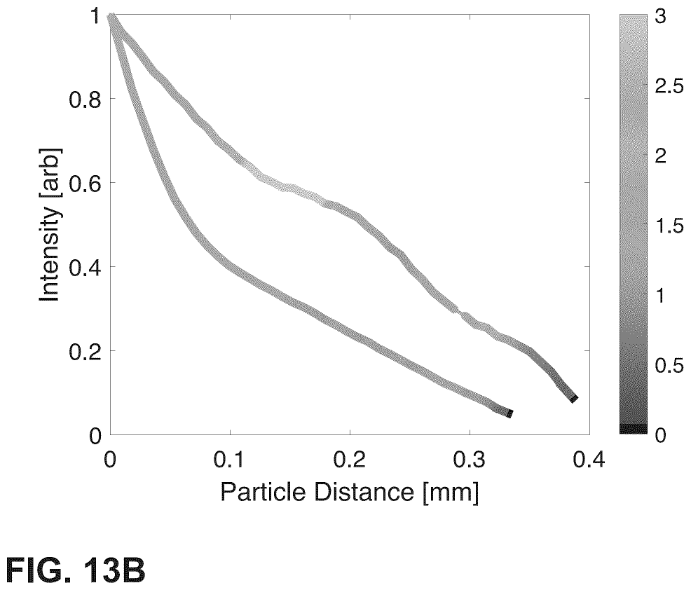

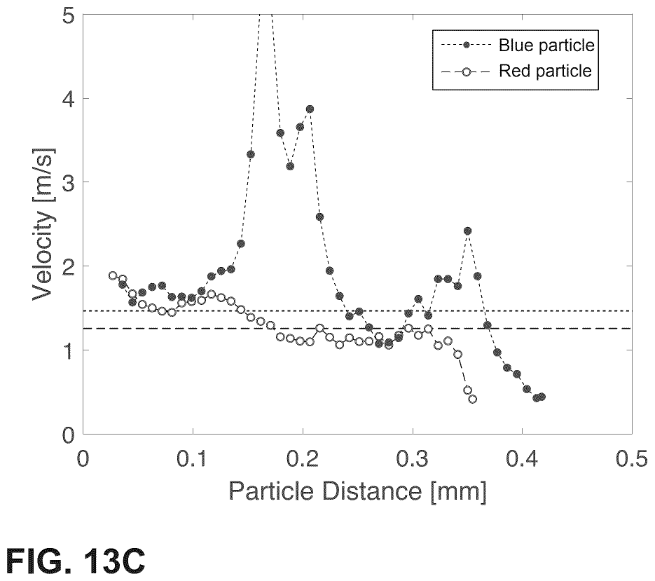

Another method of extracting quantitative information from the streak data is to break up (discretize) each streak into smaller sub-intervals to obtain a more finely-resolved estimate of both the particle velocity and direction along the streak. The two streaks from FIG. 12B are plotted again in FIG. 13A in their respective colors. Only the data from the starting point of the streak to the ending point are plotted, and intensities of the remaining data are scaled between zero and unity. These data are smoothed slightly (gray data) to remove the small pixel-to-pixel intensity changes that are most visible in the blue profile. The smoothed streak profiles are then divided into smaller sub-intervals in time, and using the photodiode-monitored intensity decay profile in time, the velocity of the particle during each sub-interval is computed. The streak intensity decay profiles are plotted in FIG. 13B, and colored by the velocity of the particle in each sub-interval. The velocity of each sub-interval is also plotted versus particle distance in FIG. 13C. The red-illuminated particle moves at a roughly constant velocity, where the mean velocity computed over the full pulse width duration is indicated by the red dashed line in FIG. 13C. This roughly constant velocity of the red-illuminated particle also agrees with the results plotted in FIG. 12B, where the streak intensity decay profile from the image matches closely with that of the photodiode monitor. The blue-illuminated particle exhibits noisier velocity values using this sub-interval analysis, with velocities exceeding 5 m/s near the second quarter-interval of the streak. The first and third quarters of the streak generally fall within the 1 m/s to 2 m/s range, albeit with oscillations corresponding to the variation in the pixel intensity of the raw image which are then coupled into the analysis via the comparison to the smooth monitor photodiode decay profile. Different smoothing methods and sub-interval bounds may be used to increase the quality of the data. Nevertheless, these results demonstrate the general utility of the extraction of the velocity over the duration of the particle streak.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of determining velocity of particles, the method comprising:
driving an LED with a trigger pulse to generate a pulse of light from the LED having an intensity that decays;
measuring the intensity of the pulse of light as the intensity decays over time whereby the measured intensity comprises a correlation between intensity and time;
illuminating a moving particle utilizing the pulse of light;
capturing an image comprising a streak formed by the moving particle while the moving particle is illuminated by the pulse of light;
determining a distance traveled by the moving particle utilizing a measured distance between first and second points on the streak; determining a decay in the intensity of the streak between the first and second points;
utilizing the correlation between intensity and time to determine the time to move the distance; and
determining a velocity of the moving particle based on a ratio of the distance traveled by the moving particle to the time to move the distance.

2. The method of claim 1, including:
determining a distance traveled by the moving particle includes determining a three dimensional distance traveled by the moving particle.

3. The method of claim 2, wherein:
the LED comprises a first LED that emits light having a first characteristic; and including:
driving a second LED with a trigger pulse to generate a pulse of light from the second LED having an intensity that decays, wherein the second LED emits light having a second characteristic;
measuring the intensity of the pulse of light from the second LED;
illuminating adjacent first and second volumes with pulses of light from the first and second LEDs, respectively;
wherein the streak comprises first and second portions formed by illumination of a particle by pulses of light from the first and second LEDs, respectively;
utilizing differences in the first and second characteristics to determine a direction of movement of the particle.

4. The method of claim 3, wherein:
the first characteristic comprises a first color;
the second characteristic comprises a second color;
the first portion of the streak is a selected one of the first and second colors;
the second portion of the streak is the other of the first and second colors.

5. The method of claim 4, including:
seeding a flowstream with particles that are illuminated by pulses of light from the first and second LEDs.

6. The method of claim 5, wherein:
the adjacent first and second volumes comprise side-by-side sheets in portions of the flowstream.

7. The method of claim 6, wherein:
the flowstream is seeded with particles utilizing a jet nozzle having an axis that is transverse to the side-by-side sheets.

8. The method of claim 3, wherein:
the image is captured utilizing a single camera.

9. The method of claim 1, wherein:
the streak includes a curved portion; and including:
determining velocity and direction of the particle along the curved portion of the streak.

10. The method of claim 1, including:
discretizing the streak into a plurality of segments;
determining the velocity of the particle for each segment utilizing the measured intensity of the pulse of light.

11. The method of claim 1, including:
directing a first portion of the pulse of light to a detector to measure the intensity of the pulse of light;
directing a second portion of the pulse of light into a flowfield to illuminate particles in the flowfield.

12. A method of measuring velocity and direction of a flowfield, the method comprising:
seeding the flowfield with particles;
illuminating particles in the flowfield utilizing first and second side-by-side sheets of pulsed light comprising first and second colors of light, respectively;
wherein the first sheet of pulsed light is formed by a first LED that emits a pulse of light, and wherein the intensity of the pulse of light decays to define a first decay profile comprising light intensity over time;
wherein the second sheet of pulsed light is formed by a second LED that emits a pulse of light, and wherein the intensity of the pulse of light decays to define a second decay profile comprising light intensity over time;
capturing images of the illuminated particles utilizing a camera such that the images of the illuminated particles comprise streaks of the first and second colors, and wherein intensities of the streaks decay along the lengths of streaks;
measuring the first and second decay profiles utilizing a portion of the pulsed light from the first and second LEDs;
utilizing the intensities of the measured first and second decay profiles to determine velocities and directions of movement of particles along paths corresponding to the streaks.

13. The method of claim 12, wherein:
the lengths of the streaks correspond to distances traveled by particles while illuminated by the pulsed light; and including:
determining distances traveled by particles utilizing lengths of the streaks.

14. The method of claim 13, wherein:
the first and second decay profiles comprise a correlation between intensity of the first and second pulses of light, respectively, and time; and including:
utilizing the decay in light intensity with time to determine times required for the particles to travel the distances;
determining velocities of the particles based on ratios of the distances to the times required to travel the distances.

15. The method of claim 14, including:
forming streak profiles comprising streak intensity vs particle distance;
dividing the streak profiles into smaller sub-intervals of time; and
determining the velocities of particles during the sub-intervals using at least a selected one of the measured first and second decay profiles.

16. The method of claim 12, wherein:
the directions of particles in three dimensions are determined, at least in part, utilizing changes in colors of streaks corresponding to individual particles that have moved in portions of both the first and second sheets of pulsed light.

17. The method of claim 12, including:
driving the first and second LEDs utilizing a circuit that outputs a pulse.

18. A method for determining movement of particles, the method comprising:
utilizing first and second LEDs to form pulses of light having first and second colors, respectively, wherein intensities of the pulses of light vary during the pulses;
illuminating particles in adjacent first and second volumes of a flowfield with pulsed light from the first and second LEDs, respectively;
utilizing a camera to acquire images of particles in the first and second volumes, wherein the images comprise streaks;
measuring the intensity of light during the pulses to form intensity profiles that correlate light intensity and time;
utilizing the intensity profiles to determine directions of movement of the particles; and
utilizing two-color streaks comprising segments having first and second colors to determine if a component of movement along an axis of the camera is positive or negative based on an orientation of the first and second color segments of the two-color streaks.

19. The method of claim 1, wherein:
the intensities of the light pulses emitted by the first and second LEDs decays over time.

20. The method of claim 19, wherein:
the images are acquired utilizing a pair of cameras that are configured to each view the same scattering angle and field-of-view at a measured location.
